(19) United States
(12) Patent Application Publication
(10) Pub. No.: US 2013/0114418 A1
(43) Pub. Date: May 9, 2013

(54) METHODS AND APPARATUS FOR WIRELESS COMMUNICATION

(71) Applicants: Keiichi KUBOTA, Weybridge (GB); Mitsuya SAITO, Camberley (GB); Brian MARTIN, Farnham (GB)

(72) Inventors: Keiichi KUBOTA, Weybridge (GB); Mitsuya SAITO, Camberley (GB); Brian MARTIN, Farnham (GB)

(73) Assignee: RENESAS MOBILE CORPORATION, TOKYO (JP)

(21) Appl. No.: 13/291,699

(22) Filed: Nov. 8, 2011

(30) Foreign Application Priority Data
Nov. 7, 2011 (GB) 1119211.9

(51) Int. Cl. H04W 36/30; H04W 24/00

(52) U.S. Cl. 370/248; 370/332; 370/252

(57) ABSTRACT

The invention relates to methods, apparatus and computer program products for enabling mobility in a downlink packet access service in a wireless communications network. At a user equipment, packet data is received from a set of one or more serving downlink shared channel cells simultaneously via one or more respective shared downlink channels and a measurement report associated with the downlink packet access service is transmitted to the network. The service is capable of initiating an addition or removal of at least one, or replacement of any, of the serving downlink shared channel cells in the set on the basis of the transmitted measurement report.

### CROSS-REFERENCE TO RELATED APPLICATION

This application claims the benefit under 35 U.S.C. §119 of UK Patent Application No. 1119211.9 filed on Nov. 7, 2011, the entire disclosure of which is incorporated herein by reference.

### TECHNICAL FIELD

The present invention relates to wireless communications networks. In particular, but not exclusively, the present invention relates to methods, apparatus, and computer program products for enabling mobility in a downlink packet access service.

### BACKGROUND

The following abbreviations that may be found in the specification and/or the drawing figures are defined as follows:

3GPP third generation partnership project

CPICH common pilot channel

DCH dedicated channel

DPCH dedicated physical channel

eNB evolved Node B

FDD frequency-division duplex

HSDPA high speed downlink packet access

HS-DSCH high speed downlink shared channel

HS-SCCH high speed shared control channel

IE information element

LTE long term evolution (EUTRA network)

LTE-A LTE advanced

NW network

RAN radio access network

RAN2 3GPP RAN working group 2

RNC radio network controller

RRC radio resource control

RRM radio resource management

RSCP received signal code power

TDD time-division duplex

UE user equipment

UMTS universal mobile telecommunication system

UTRAN universal terrestrial radio access network

WCDMA wideband code division multiple access

HSDPA services were introduced in 3GPP Release 5. Up to 3GPP Release 10, HSDPA used only one serving HS-DSCH cell on a single carrier frequency and the NW selects the best quality cell for the serving HS-DSCH cell. In 3GPP RAN plenary meeting #53, RAN plenary agreed to introduce a HSDPA multiflow (or ‘multipoint’) data transmission work item (WI) in 3GPP Release 11 (RP-111375) where multiple serving HS-DSCH cells serve packet data to a UE simultaneously. It has also been suggested that HSDPA multiflow operation is introduced over more than one carrier frequency.

No mobility procedures have yet been proposed for HSDPA multiflow data transmission, but it has been suggested that RAN2 should introduce a new mobility procedure for HSDPA multiflow.

3GPP RRC Protocol specification 25.331 specifies an event triggered measurement, ‘event 1d’ for reporting the best quality cell. However, event 1d cannot be used for HSPDA multiflow mobility because more than one serving HS-DSCH cell can be configured for the operation. For example, if the NW configures one additional serving HS-DSCH cell, then the additional serving HS-DSCH cell should be the second best quality cell. There is currently no means to report the second best quality cell in the 3GPP specifications.

InterDigital™ made a RAN2 contribution, R2-115388, relating to mobility for HSDPA multiflow. However, the solution proposed by InterDigital does not provide the full toolset for RRM and can only be used for limited scenarios.

It would therefore be desirable to provide procedures by which candidate cell(s) for multiflow downlink packet access services such as HSDPA multiflow data transmission can be reported. In particular, it would be desirable to provide a similar level of flexibility that is available for DPCH soft handover as the mobility and RRM requirements for HSDPA multiflow data transmission are similar.

### SUMMARY

In accordance with first embodiments, there is a method for enabling mobility in a downlink packet access service in a wireless communications network, the method comprising, at a user equipment:

receiving packet data from a set of one or more serving downlink shared channel cells simultaneously via one or more respective shared downlink channels; and

transmitting a measurement report associated with the downlink packet access service,

wherein the service is capable of initiating an addition or removal of at least one, or replacement of any, of the serving downlink shared channel cells in the set on the basis of the transmitted measurement report.

In accordance with second embodiments, there is apparatus for use in enabling mobility in a downlink packet access service in a wireless communications network, said apparatus comprising a processing system comprising at least one processor and at least one memory storing a set of computer instructions, in which the processing system is arranged to cause the apparatus at least to, at a user equipment:

receive packet data from a set of one or more serving downlink shared channel cells simultaneously via one or more respective shared downlink channels; and

transmit a measurement report associated with the downlink packet access service,

wherein the service is capable of initiating an addition or removal of at least one, or replacement of any, of the serving downlink shared channel cells in the set on the basis of the transmitted measurement report

In accordance with third embodiments, there is a method for enabling mobility in a downlink packet access service in a wireless communications network, the method comprising, at a network device:

transmitting packet data from a set of one or more serving downlink shared channel cells simultaneously via one or more respective shared downlink channels to a user equipment;

receiving, from the user equipment, a measurement report associated with the downlink packet access service; and

initiating an addition or removal of at least one, or replacement of any, of the serving downlink shared channel cells in the set on the basis of the received measurement report.

In accordance with fourth embodiments, there is apparatus for use in enabling mobility in a downlink packet access service in a wireless communications network, said apparatus comprising a processing system comprising at least one processor and at least one memory storing a set of computer instructions, in which the processing system is arranged to cause the apparatus at least to:

transmit packet data from a set of one or more serving downlink shared channel cells simultaneously via one or more respective shared downlink channels to a user equipment;

receive, from the user equipment, a measurement report associated with the downlink packet access service; and

initiate an addition or removal of at least one, or replacement of any, of the serving downlink shared channel cells in the set on the basis of the received measurement report.

In accordance with fifth embodiments, there is a computer program product comprising a non-transitory computer-readable storage medium having computer readable instructions stored thereon, the computer readable instructions being executable by a computerised device to cause the computerised device to perform a method for enabling mobility in a downlink packet access service in a wireless communications network, the method comprising, at a user equipment:

receiving packet data from a set of one or more serving downlink shared channel cells simultaneously via one or more respective shared downlink channels;

transmitting a measurement report associated with the downlink packet access service,

wherein the service is capable of initiating an addition or removal of at least one, or replacement of any, of the serving downlink shared channel cells in the set on the basis of the transmitted measurement report.

In accordance with sixth embodiments, there is a computer program product comprising a non-transitory computer-readable storage medium having computer readable instructions stored thereon, the computer readable instructions being executable by a computerized device to cause the computerized device to perform a method for enabling mobility in a downlink packet access service in a wireless communications network, the method comprising:

transmitting packet data from a set of one or more serving downlink shared channel cells simultaneously via one or more respective shared downlink channels to a user equipment;

receiving, from the user equipment, a measurement report associated with the downlink packet access service; and

initiating an addition or removal of at least one, or replacement of any, of the serving downlink shared channel cells in the set on the basis of the received measurement report.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 illustrates an exemplary wireless communications network according to embodiments.

FIG. 2 illustrates an exemplary wireless communications network according to embodiments.

FIG. 3 illustrates an exemplary wireless communications network according to embodiments.

FIG. 4 illustrates an exemplary wireless communications network according to embodiments.

FIG. 5 illustrates an exemplary wireless communications network according to embodiments.

FIG. 6 shows a flow diagram according to embodiments.

FIG. 7 shows a flow diagram according to embodiments.

FIG. 8 illustrates an exemplary wireless communications network according to embodiments.

### DETAILED DESCRIPTION

Embodiments relate to methods, apparatus and computer software for enabling mobility in a downlink packet access service in a wireless communications network. Packet data is transmitted from a set of one or more serving downlink shared channel cells simultaneously via one or more respective shared downlink channels to a UE. The UE receives pilot channel signals broadcast by cells in the network. If a given metric of a pilot channel signal from a given cell received at the UE meets one or more of a plurality of reporting criteria associated with the downlink packet access service, the UE generates a measurement report and transmits the measurement report to a transceiver network entity in the wireless communications network. The pilot channel signal may for example comprise a primary CPICH. The transceiver network entity may for example comprise a base station, Node B or eNB.

The given metric may comprise the pathloss, a measure of signal strength and/or a measure of signal quality.

In embodiments, the reporting criteria may for example require the given cell to be in one of:

a) the set of serving downlink shared channel cells;

b) a set of one or more cells monitored by the user equipment in relation to the downlink packet access service;

c) the set of serving downlink shared channel cells or the set of one or more cells monitored by the user equipment in relation to the downlink packet access service;

d) a set of one or more cells detected by the user equipment; or

e) the set of one or more cells detected by the user equipment or the set of one or more cells monitored by the user equipment in relation to the downlink packet access service.

The measurement report is passed to a network controller entity, such as an RNC, which is responsible for maintaining one or more UE contexts, controlling one or more transceiver network entities in the network as well as providing radio resource management and mobility management functionality. The received measurement report is processed by the network controller entity which may initiate an addition or removal of at least one, or replacement of any, of the serving downlink shared channel cells in the set of serving downlink shared channel cells which are currently serving packet data to the UE via shared downlink channels.

Embodiments therefore provide procedures which allow any serving downlink shared channel cell from a set of one or more serving downlink shared channel cells to be removed or replaced by another cell, or a new serving downlink shared channel cell to be added to the set of one or more serving downlink shared channel cells based on measured cell quality in the network, i.e. mobility procedures for multiflow downlink packet access services are enabled.

A neighbour cell list is a list of neighbour cells that a UE maintains (denoted CELL_INFO_LIST in 3GPP specification 25.331). The UE takes measurements of cells in the neighbour cell list and reports them to the network if configured to do so.

An active set is defined as a set of one or more cells which belong to the active set. User information is sent from all cells in an active see. In FDD, the cells in the active set are involved in soft handover. In TDD, the active set comprises one cell only. The UE shall only consider active set cells included in the variable neighbour cell list for measurement; i.e. active set cells not included in the neighbour cell list shall not be considered in any event evaluation and measurement reporting.

The current carrier frequency is defined as the carrier frequency that is currently used by the UE. In case of dual cell or dual band configurations, the serving cell carrier frequency, for example the serving HS-DSCH cell carrier frequency, is treated as the current carrier frequency.

A detected set is defined as a set of cells detected by the UE, which are neither in the neighbour cell list nor in the active set belonging to the detected set. Reporting of measurements of the detected set is only applicable to intra-frequency and inter-frequency measurements made by UEs in a dedicated channel state where a dedicated physical channel is allocated to the UE (e.g. denoted CELL_DCH in 3GPP specification 25.331).

A monitored set is defined as a set of cells which are not included in the active set, but are included in the neighbour cell list.

A serving downlink shared channel cell is defined as a cell associated with an access point performing transmission and reception of the serving downlink shared channel radio link for a given UE. A serving downlink shared channel cell is always part of the current active downlink shared channel set of the UE. In embodiments, a serving downlink shared channel cell comprises a serving HS-DSCH cell associated with a UTRAN access point performing transmission and reception of the HS-DSCH radio link for a given UE.

A secondary serving downlink shared channel cell is a cell, other than the serving downlink shared channel cell, where the UE is configured to simultaneously monitor a shared control channel set and receive data on the downlink shared channel if it is scheduled in that cell. There can be multiple secondary serving downlink shared channel cells. If the UE is configured with two uplink frequencies, the first secondary serving downlink shared channel cell is the secondary serving downlink shared channel cell that is associated with the secondary uplink carrier frequency. In embodiments, a secondary serving downlink shared channel cell comprises a secondary serving HS-DSCH cell and the shared control channel comprises a HS-SCCH.

A downlink shared channel active set is defined as a set of one or more serving downlink shared channel cells which are involved in simultaneous downlink packet access multiflow data transmission to a UE on a single carrier frequency. In multiple carrier frequency configurations, each carrier frequency may have its own downlink shared channel active set. In embodiments, the downlink shared channel active set comprises a ‘HS-DSCH active set’ of serving HS-DSCH cells and the downlink packet access multiflow data transmission comprises HSDPA multiflow data transmission.

A downlink shared channel monitored set is defined as a set of non-serving downlink shared channel cells which are not included in the downlink shared channel active set, but which are included in the neighbour cell list. In embodiments, the non-serving downlink shared channel cells comprise non-serving HS-DSCH cells and the downlink shared channel monitored set comprises a HS-DSCH monitored set.

The downlink packet access service could for example comprise an HSDPA multiflow data transmission service where packet data can be simultaneously transmitted to each UE from multiple serving HS-DSCH cells. Each HS-DSCH serving cell transmits packet data to a UE via a respective downlink shared channel, for example a HS-DSCH. Cells monitored by the UE in relation to the downlink packet access service could for example comprise HS-DSCH monitored cells. Embodiments below are primarily described in relation to an HSDPA multiflow data transmission service, but embodiments can equally be applied in other downlink packet access services in UMTS, LTE, LTE-A or other environments.

Embodiments introduce six intra-frequency reporting events as described below which enable mobility procedures for downlink packet access multiflow data transmission. These exemplary embodiments are described in relation to HSDPA multiflow data transmission with an active set of one or more serving HS-DSCH cells. The six intra-frequency reporting events allow the addition of a cell to the HS-DSCH active set, removal of any cell from the HS-DSCH active set, or replacement of any cell in the HS-DSCH active set in response to one or more of a plurality of reporting criteria being met.

A first intra-frequency reporting event provides a capability to add a cell to the HS-DSCH active set. The reporting criteria for the first intra-frequency reporting event comprise a given metric of the pilot channel signal of a given cell received at the UE entering a reporting range. The given metric may for example comprise the pathloss, a measure of signal strength and/or a measure of signal quality.

The pilot channel signal may for example comprise the primary CPICH of the given cell. The measure of signal strength and/or measure of signal quality may for example relate to the pathloss calculated as CPICH Ec/N0 (a carrier to noise signal ratio measure of signal quality) or CPICH RSCP (a measure of both signal strength and signal quality). The reporting range comprises a measure relative to the strength and/or quality of signal received from one or more of the serving HS-DSCH cells, for example an average of the strength and/or quality of signal received from all cells in the active HS-DSCH set, possibly with some hysteresis adjustment factor. The contents of this paragraph are also relevant for the second to sixth intra-frequency reporting events described below. The pathloss may be calculated as Pathloss (dB)=Primary CPICH transmitter power−CPICH RSCP.

In embodiments, the reporting criteria for the first intra-frequency event also comprise the given cell being one of:

a) a cell in the HS-DSCH active set;

b) a cell in the HS-DSCH monitored set;

c) a cell in the HS-DSCH active set or a cell in the HS-DSCH monitored set;

d) a cell in the detected set; or

e) a cell in the detected set or a cell in the HS-DSCH monitored set.

Which one of a), b), c), d) or e) in the preceding paragraph affects the first intra-frequency reporting event (i.e. which cells should be considered for evaluating whether the event has occurred or not) depends on configuration of the UE (this may for example be controlled using a configurable ‘triggering condition’ parameter). In some embodiments, such configuration is predetermined, whereas in other embodiments it is carried out according to configuration control data received from the NW.

For example in some embodiments, the reporting criteria for the first intra-frequency reporting event are only met if the given metric of a given cell enters a reporting range and the given cell is in the HS-DSCH monitored set. For example in other embodiments, the reporting criteria for the first intra-frequency reporting event are only met if the given metric of a given cell enters a reporting range and the given cell is in the detected set or the HS-DSCH monitored set.

When the UE detects the reporting criteria for the first intra-frequency reporting event, the UE generates and transmits a measurement report which informs the network that the event criteria have been met. The measurement report includes measurement data associated with the pathloss, signal strength and/or signal quality of signals received at the user equipment from one or more cells operating in the network.

The one or more cells operating in the network comprise:

a) cells in the HS-DSCH active set;

b) cells in the HS-DSCH monitored set;

c) cells in the HS-DSCH active set and cells in the HS-DSCH monitored set;

d) cells in the detected set; or

e) cells in the detected set and cells in the HS-DSCH monitored set.

Which measurement data the UE includes in the measurement report depends on configuration of the UE (this may for example be controlled using a configurable triggering condition parameter). In some embodiments, such configuration is predetermined, whereas in other embodiments it is carried out according to configuration control data received from the NW. The user equipment is configured to include measurement data associated with either a), b), c), d) or e) given in the preceding paragraph in the measurement report. In embodiments, the measurement data to be included in the measurement report is generated according to a new IE “Reporting cell status” (such as report cells in the HS-DSCH active and HS-DSCH monitored sets), for example named “HS-DSCH Reporting cell status”.

Upon receipt of the measurement report generated in response to occurrence of the first intra-frequency reporting event, the NW can decide to initiate addition of the given cell to the HS-DSCH active set.

In embodiments, a reporting deactivation threshold is defined and the UE deactivates the measurement reporting when the number of HS-DSCH active set cells becomes more than the reporting deactivation threshold.

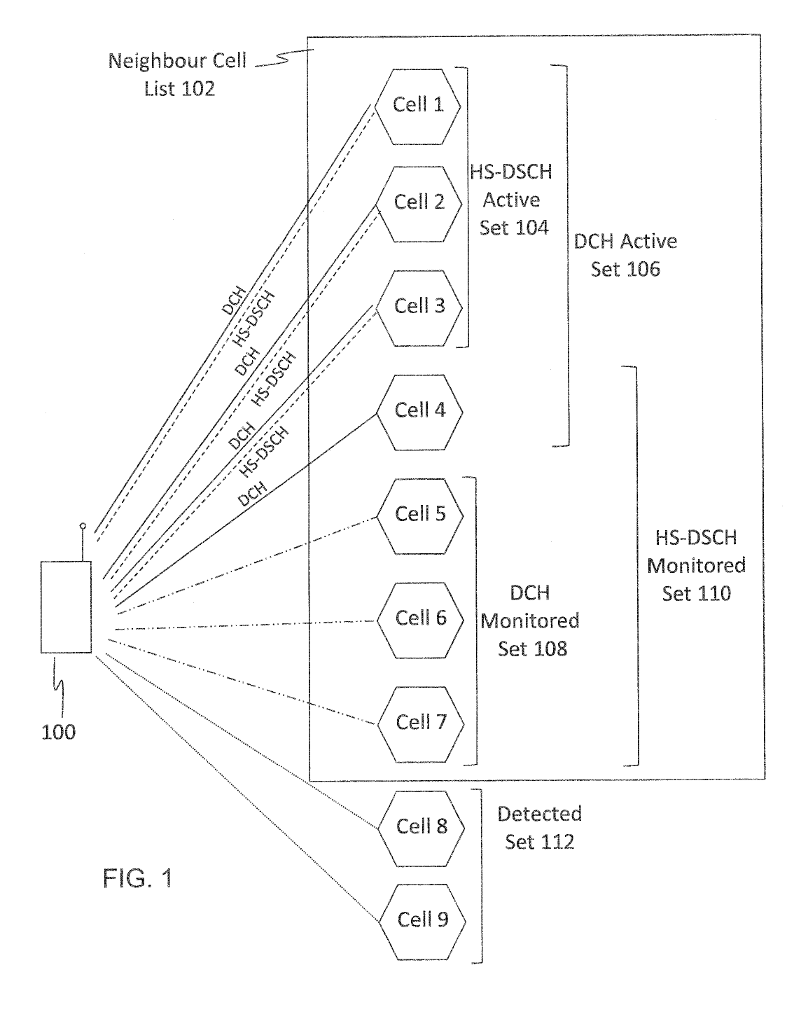

FIG. 1 illustrates an exemplary wireless communications network according to embodiments. The network includes a UE 100 and a number of cells, Cell 1, Cell 2, . . . , Cell 9. Cells 1 to 3 are in a HS-DSCH active set 104 such that packet data is transmitted simultaneously to UE 100 three via respective HS-DSCHs. Cells 4 to 7 are in a HS-DSCH monitored set 110. Cells 8 and 9 are in a detected set 112. Cells 1 to 4 are in a dedicated channel communication service active set, in this case DCH active set 106, where data may pass via an uplink and a downlink between UE 100 and the respective cells. Cells 5 to 7 are in a dedicated channel communication service monitored set, in this case DCH monitored set 108.

Although, FIG. 1 illustrates DCH being configured for each radio link, where a serving HS-DSCH cell is configured, it should be noted that configuration of a DCH is not necessary to configure a serving HS-DSCH cell. For example, if E-DCH for uplink and HS-DSCH for downlink are configured and all logical channels are mapped on E-DCH and HS-DSCH, then DCH will not be configured for the radio links.

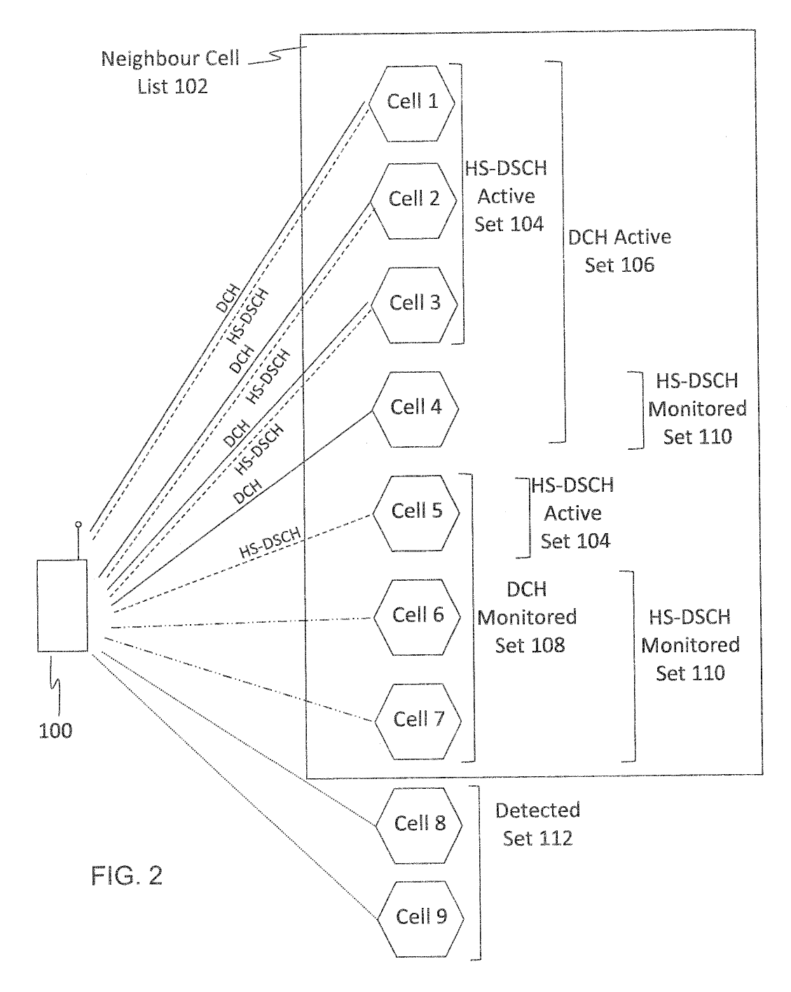

FIG. 2 illustrates an exemplary wireless communications network according to embodiments. In particular, FIG. 2 illustrates a scenario after a first intra-frequency reporting event has occurred in relation to FIG. 1 and acted upon by the NW. In this case, the metric of the pilot channel signal of Cell 5 enters a reporting range thus meeting the reporting criteria for the first intra-frequency reporting event. UE 100 generates a measurement report accordingly and transmits the generated measurement report to the NW and the NW adds Cell 5 to HS-DSCH active set 104. HS-DSCH monitored set 110 can be seen to now only include Cells 4, 6 and 7.

In the embodiments illustrated in FIG. 2, there are no changes to the DCH active set 106, the DCH monitored set 108 or the detected set 112, although this may not necessarily be the case. In some embodiments, a serving HS-DSCH cell is part of the active set (DCH active set) such that if a cell is added to the HS-DSCH active set, then that cell is added to the DCH active set simultaneously. In other embodiments, addition of a serving HS-DSCH cell can occur independently of the DCH active set, such that if a cell is added to the HS-DSCH active set, then adding that cell to the DCH active set is optional.

A second intra-frequency reporting event provides a capability to remove any cell from the HS-DSCH active set. The reporting criteria for the second intra-frequency reporting event comprise a metric of the pilot channel signal of a given cell received at the UE leaving a reporting range.

In embodiments, the reporting criteria for the second intra-frequency reporting event further comprise the given cell being one of:

a) a cell in the HS-DSCH active set;

b) a cell in the HS-DSCH monitored set; or

c) a cell in the HS-DSCH active set or a cell in the HS-DSCH monitored set;

Which one of a), b), or c) in the preceding paragraph affects the second intra-frequency reporting event depends on configuration of the UE (this may for example be controlled using a configurable triggering condition parameter). In some embodiments, such configuration is predetermined, whereas in other embodiments it is carried out according to configuration control data received from the NW.

For example in some embodiments, the reporting criteria for the second intra-frequency reporting event are only met if the metric of a given cell leaves a reporting range and the given cell is a HS-DSCH monitored set cell.

When the UE detects the reporting criteria for the second intra-frequency reporting event, the UE generates and transmits a measurement report which informs the network that the event criteria have been met. The measurement report includes measurement data associated with the pathloss, signal strength and/or signal quality of signals received at the user equipment from one or more cells operating in the network.

The one or more cells operating in the network comprise:

a) cells in the HS-DSCH active set;

b) cells in the HS-DSCH monitored set;

c) cells in the HS-DSCH active set and cells in the HS-DSCH monitored set;

d) cells in the detected set; or

e) cells in the detected set and cells in the HS-DSCH monitored set.

Which measurement data the UE includes in the measurement report depends on configuration of the UE. In some embodiments, such configuration is predetermined, whereas in other embodiments it is carried out according to configuration control data received from the NW. The user equipment is configured to include measurement data associated with either a), b), c), d) or e) given in the preceding paragraph in the measurement report. In embodiments, the measurement data to be included in the measurement report is generated according to a new IE “Reporting cell status” (such as report cells in the HS-DSCH monitored set), for example named “HS-DSCH Reporting cell status”.

Upon receipt of the measurement report generated in response to occurrence of the second intra-frequency reporting event, the NW can decide to initiate removal of the given cell from the HS-DSCH active set.

If the HS-DSCH active set only contains a single HS-DSCH serving cell, then removal of the single HS-DSCH serving cell in response to occurrence of the second intra-frequency reporting event may result in deactivation or de-configuration of HSDPA multiflow data transmission. However, the NW may choose to ignore the second intra-frequency reporting event and maintain the number of serving HS-DSCH cells at one. HSDPA multiflow operation could also be deactivated based on user data activity.

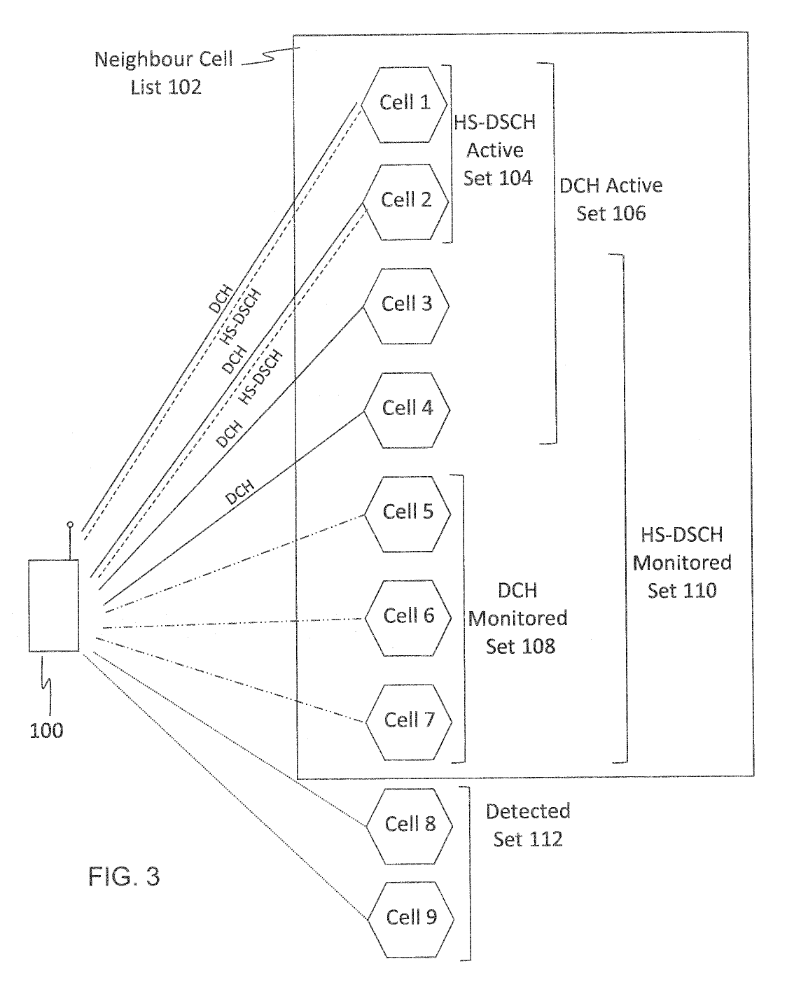

FIG. 3 illustrates an exemplary wireless communications network according to embodiments. In particular, FIG. 3 illustrates a scenario after a second intra-frequency reporting event has occurred in relation to FIG. 1 and acted upon by the NW. In this case, a metric of the pilot channel signal of Cell 3 in HS-DSCH active set 104 leaves a reporting range thus meeting the reporting criteria for the second intra-frequency reporting event. UE 100 generates a measurement report accordingly and transmits the generated measurement report to the NW and the NW removes Cell 3 from HS-DSCH active set 104. HS-DSCH monitored set 110 can be seen to additionally now include Cell 3.

In the embodiments illustrated in FIG. 3, there are no changes to DCH active set 106, DCH monitored set 108 or detected set 112, although this may not necessarily be the case. In some embodiments, a serving HS-DSCH cell is a part of the active set (DCH active set) such that if a cell is removed from the HS-DSCH active set, then that cell is also removed from the DCH active set simultaneously. In other embodiments, removal of a serving HS-DSCH cell can occur independently of the DCH active set, such that if a cell is removed from the HS-DSCH active set, then removing that cell from the DCH active set is optional.

A third intra-frequency reporting event provides a capability to replace any cell in the HS-DSCH active set with a new cell. The reporting criteria for the third intra-frequency reporting event comprise a metric of the pilot channel signal of a given cell received at the UE becoming better than the same metric of a pilot channel signal received at the user equipment from at least one serving cell in the HS-DSCH active set.

In the case of a pathloss metric, then ‘better’ denotes ‘lower’. In the case of measure of signal strength or signal quality metric, then ‘better’ denotes ‘higher’.

When the UE detects the reporting criteria for the third intra-frequency reporting event, the UE generates and transmits a measurement report which informs the network that the event criteria have been met. The measurement report includes measurement data associated with the pathloss, signal strength and/or signal quality of signals received at the user equipment from one or more cells operating in the network.

The one or more cells operating in the network comprise:

a) cells in the HS-DSCH active set;

b) cells in the HS-DSCH monitored set;

c) cells in the HS-DSCH active set and cells in the HS-DSCH monitored set;

d) cells in the detected set; or

e) cells in the detected set and cells in the HS-DSCH monitored set.

Which measurement data the UE includes in the measurement report depends on configuration of the UE. In some embodiments, such configuration is predetermined, whereas in other embodiments it is carried out according to configuration control data received from the NW. The user equipment is configured to include measurement data associated with either a), b), c), d) or e) given in the preceding paragraph in the measurement report. In embodiments, the measurement data to be included in the measurement report is generated according to a new IE “Reporting cell status” (such as report cells in the HS-DSCH active and HS-DSCH monitored sets), for example named “HS-DSCH Reporting cell status”.

Upon receipt of the measurement report generated in response to occurrence of the third intra-frequency reporting event, the NW can decide to initiate replacement of a cell in the HS-DSCH active set. In embodiments, the replaced cell comprises the cell in the HS-DSCH active set having the worst pathloss, signal strength and/or signal quality of pilot channel signal received at the user equipment.

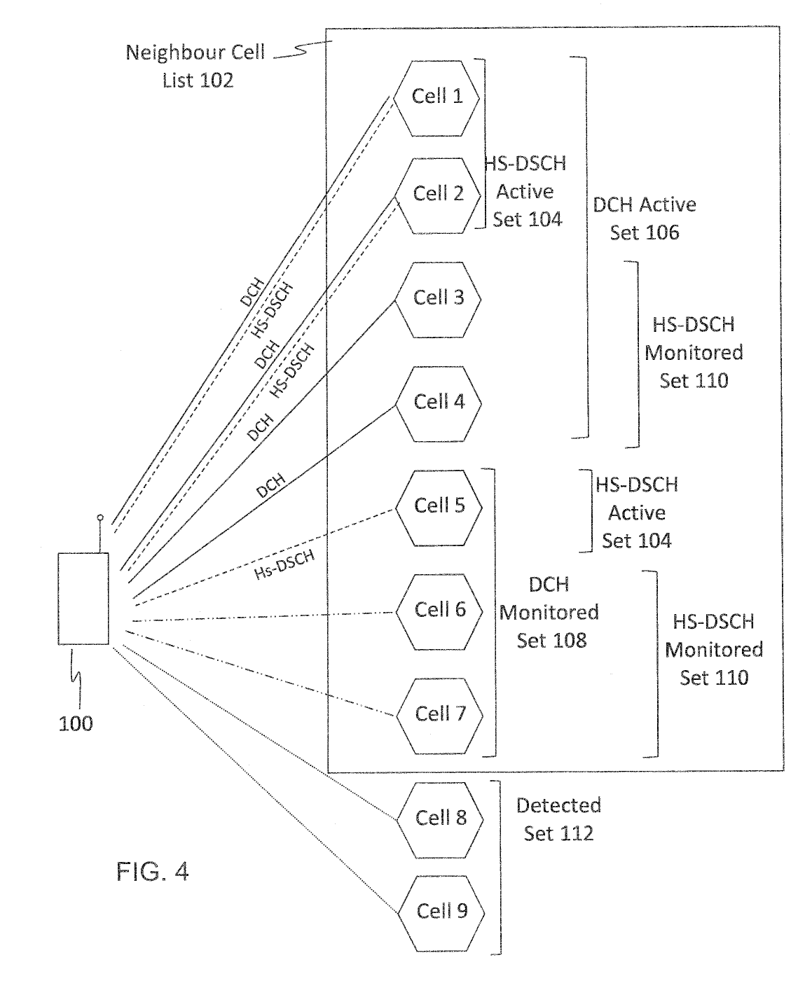

FIG. 4 illustrates an exemplary wireless communications network according to embodiments. In particular, FIG. 4 illustrates a scenario after a third intra-frequency reporting event has occurred in relation to FIG. 1 and acted upon by the NW. In this case, a metric of the pilot channel signal of Cell 5 in HS-DSCH monitored set 110 becomes better than the same metric of a pilot channel signal received at UE 100 from Cell 3 in HS-DSCH active set 104 thus meeting the reporting criteria for the third intra-frequency reporting event. UE 100 generates a measurement report accordingly and transmits the generated measurement report to the NW and the NW replaces Cell 3 in HS-DSCH active set 104 with Cell 5. HS-DSCH monitored set 110 can be seen to now include Cell 3 instead of Cell 5.

In these embodiments, there are no changes to DCH active set 106, DCH monitored set 108 or detected set 112, although this may not necessarily always be the case. In some embodiments, a serving HS-DSCH cell is a part of the active set (DCH active set) such that if a cell is replaced in the HS-DSCH active set, then that cell is also replaced in the DCH active set simultaneously. In other embodiments, replacement of a serving HS-DSCH cell can occur independently of the DCH active set, such that if a cell is replaced in the HS-DSCH active set, then replacing that cell in the DCH active set is optional.

In embodiments, a replacement activation threshold is defined and the UE activates the measurement reporting when the number of HS-DSCH active set cells becomes more than or equal to the replacement activation threshold.

A fourth intra-frequency reporting event provides a capability to add a cell to the HS-DSCH active set. The reporting criteria for the fourth intra-frequency reporting event comprise a metric of the pilot channel signal of a given cell received at the UE becoming better than an absolute threshold. The absolute threshold can be predetermined or configured on the UE by the NW.

In the case of a pathloss metric, then ‘better’ denotes ‘lower’. In the case of measure of signal strength or signal quality metric, then ‘better’ denotes ‘higher’.

In embodiments, the reporting criteria for the fourth intra-frequency reporting event further comprise the given cell being one of:

a) a cell in the HS-DSCH active set;

b) a cell in the HS-DSCH monitored set;

c) a cell in the HS-DSCH active set or a cell in the HS-DSCH monitored set;

d) a cell in the detected set; or

e) a cell in the detected set or a cell in the HS-DSCH monitored set.

Which one of a), b), c), d) or e) in the preceding paragraph effects the fourth intra-frequency reporting event depends on configuration of the UE (this may for example be controlled using a configurable ‘triggering condition’ parameter). In some embodiments, such configuration is predetermined, whereas in other embodiments it is carried out according to configuration control data received from the NW.

For example in some embodiments, the reporting criteria for the fourth intra-frequency reporting event are only met if a metric of the pilot channel signal of a given cell received by the UE becomes better than an absolute threshold and the given cell is in the detected set.

When the UE detects the reporting criteria for the fourth intra-frequency reporting event, the UE generates and transmits a measurement report which informs the network that the event criteria have been met. The measurement report includes measurement data associated with the pathloss, signal strength and/or signal quality of signals received at the user equipment from one or more cells operating in the network.

The one or more cells operating in the network comprise:

a) cells in the HS-DSCH active set;

b) cells in the HS-DSCH monitored set;

c) cells in the HS-DSCH active set and cells in the HS-DSCH monitored set;

d) cells in the detected set; or

e) cells in the detected set and cells in the HS-DSCH monitored set.

Which measurement data the UE includes in the measurement report depends on configuration of the UE. In some embodiments, such configuration is predetermined, whereas in other embodiments it is carried out according to configuration control data received from the NW. The user equipment is configured to include measurement data associated with either a), b), c), d) or e) given in the preceding paragraph in the measurement report. In embodiments, the measurement data to be included in the measurement report is generated according to a new IE “Reporting cell status” (such as report cells in the HS-DSCH monitored set), for example named “HS-DSCH Reporting cell status”.

Upon receipt of the measurement report generated in response to occurrence of the fourth intra-frequency reporting event, the NW can decide to initiate addition of the given cell to the HS-DSCH active set.

In embodiments, a reporting deactivation threshold is defined and UE deactivates the measurement reporting when the number of HS-DSCH active set cells becomes more than the reporting deactivation threshold.

The addition of a cell to the HS-DSCH active set according to the fourth intra-frequency reporting event applies similarly to FIGS. 1 and 2 described above in relation to the first intra-frequency reporting event.

A fifth intra-frequency reporting event provides a capability to remove any cell from the HS-DSCH active set. The reporting criteria for the fifth intra-frequency reporting event comprise a metric of the pilot channel signal of a given cell received at the UE becoming worse than an absolute threshold. The absolute threshold can be predetermined or configured on the UE by the NW.

In the case of a pathloss metric, then ‘worse’ denotes ‘higher’. In the case of measure of signal strength or signal quality metric, then ‘worse’ denotes ‘lower’.

In embodiments, the reporting criteria for the fifth intra-frequency reporting event further comprise the given cell being one of:

a) a cell in the HS-DSCH active set;

b) a cell in the HS-DSCH monitored set; or

c) a cell in the HS-DSCH active set or a cell in the HS-DSCH monitored set;

Which one of a), b), or c) in the preceding paragraph affects the fifth intra-frequency reporting event depends on configuration of the UE (this may for example be controlled using a configurable ‘triggering condition’ parameter). In some embodiments, such configuration is predetermined, whereas in other embodiments it is carried out according to configuration control data received from the NW.

For example in some embodiments, the reporting criteria for the fifth intra-frequency reporting event are only met if a given metric of a given cell becomes worse than an absolute threshold and the given cell is an HS-DSCH monitored set cell or a HS-DSCH active set cell.

When the UE detects the reporting criteria for the fifth intra-frequency reporting event, the UE generates and transmits a measurement report which informs the network that the event criteria have been met. The measurement report includes measurement data associated with the pathloss, signal strength and/or signal quality of signals received at the user equipment from one or more cells operating in the network.

The one or more cells operating in the network comprise:

a) cells in the HS-DSCH active set;

b) cells in the HS-DSCH monitored set;

c) cells in the HS-DSCH active set and cells in the HS-DSCH monitored set;

d) cells in the detected set; or

e) cells in the detected set and cells in the HS-DSCH monitored set.

Which measurement data the UE includes in the measurement report depends on configuration of the UE. In some embodiments, such configuration is predetermined, whereas in other embodiments it is carried out according to configuration control data received from the NW. The user equipment is configured to include measurement data associated with either a), b), c), d) or e) given in the preceding paragraph in the measurement report. In embodiments, the measurement data to be included in the measurement report is generated according to a new IE “Reporting cell status” (such as report cells in the HS-DSCH active set as well as cells in the HS-DSCH monitored set), for example named “HS-DSCH Reporting cell status”.

Upon receipt of the measurement report generated in response to occurrence of the fifth intra-frequency reporting event, the NW can decide to initiate removal of the given cell from the HS-DSCH active set.

If the HS-DSCH active set only contains a single HS-DSCH serving cell, then removal of the single HS-DSCH serving cell in response to occurrence of the fifth intra-frequency reporting event may result in deactivation or de-configuration of HSDPA multiflow data transmission.

The removal of a cell from the HS-DSCH active set according to the fifth intra-frequency reporting event applies similarly to FIGS. 1 and 3 described above in relation to the second intra-frequency reporting event.

A sixth intra-frequency reporting event provides a capability to replace any cell in the HS-DSCH active set with a new cell in the DCH active set. The reporting criteria for the sixth intra-frequency reporting event comprise a given metric of the pilot channel signal of a given cell received at the UE becoming better than the same metric of a pilot channel signal received at the user equipment from at least one serving cell in the HS-DSCH active set. For the sixth intra-frequency reporting event to occur, the given cell should also comprise a cell for a DCH communication service, but should not comprise a cell in the HS-DSCH active set.

When the UE detects the reporting criteria for the sixth intra-frequency reporting event, the UE generates and transmits a measurement report which informs the network that the event criteria have been met. The measurement report includes measurement data associated with the pathloss, signal strength and/or signal quality of signals received at the user equipment from one or more cells operating in the network.

The one or more cells operating in the network comprise:

a) cells in the HS-DSCH active set;

b) cells in the HS-DSCH monitored set;

c) cells in the HS-DSCH active set and cells in the HS-DSCH monitored set;

d) cells in the detected set; or

e) cells in the detected set and cells in the HS-DSCH monitored set.

Which measurement data the UE includes in the measurement report depends on configuration of the UE. In some embodiments, such configuration is predetermined, whereas in other embodiments it is carried out according to configuration control data received from the NW. The user equipment is configured to include measurement data associated with either a), b), c), d) or e) given in the preceding paragraph in the measurement report. In embodiments, the measurement data to be included in the measurement report is generated according to a new IE “Reporting cell status” (such as report cells in the HS-DSCH monitored set), for example named “HS-DSCH Reporting cell status”.

Upon receipt of the measurement report generated in response to occurrence of the sixth intra-frequency reporting event, the NW can decide to initiate replacement of a cell in the HS-DSCH active set. In embodiments, the replaced cell comprises the cell in the HS-DSCH active set having the worst pathloss, signal strength and/or signal quality of pilot channel signal received at the user equipment.

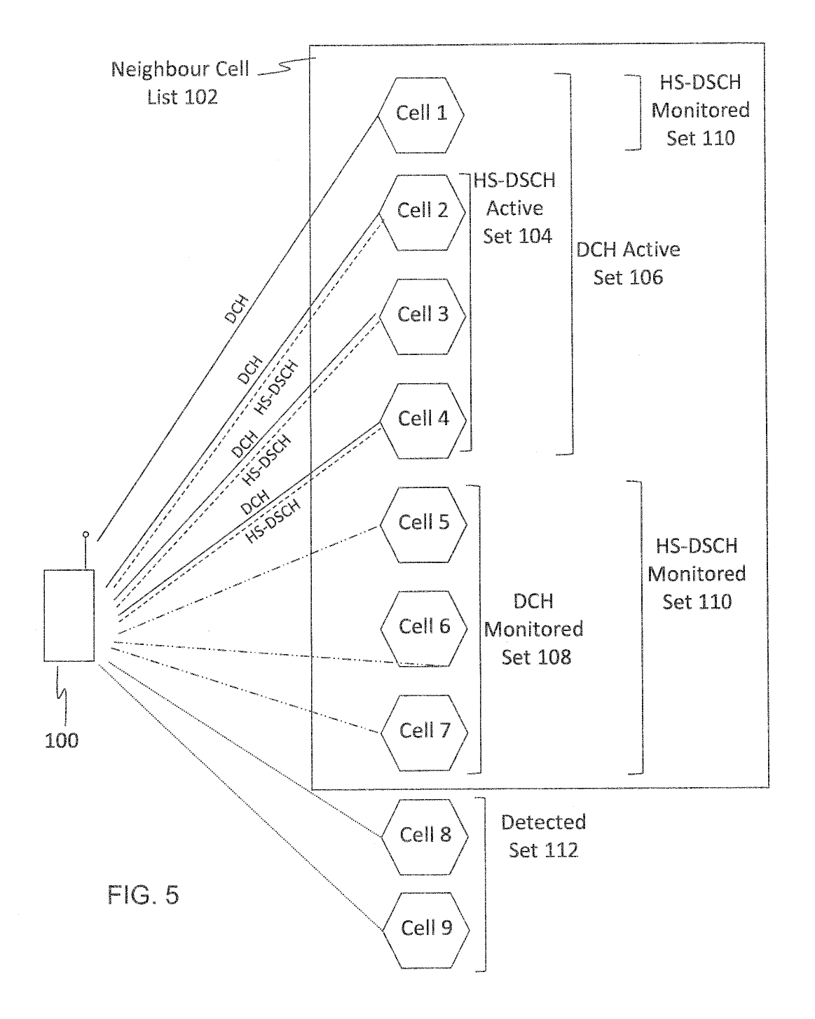

FIG. 5 illustrates an exemplary wireless communications network according to embodiments. In particular, FIG. 5 illustrates a scenario after a sixth intra-frequency reporting event has occurred in relation to FIG. 1 and acted upon by the NW. In this case, the metric of the pilot channel signal of Cell 4 in DCH active set 106 (but not in HS-DSCH active set 104) becomes better than the same metric of a pilot channel signal received at UE 100 from Cell 1 in HS-DSCH active set 104 thus meeting the reporting criteria for the sixth intra-frequency reporting event. UE 100 generates a measurement report accordingly and transmits the generated measurement report to the NW and the NW replaces Cell 1 in HS-DSCH active set 104 with Cell 4. HS-DSCH monitored set 110 can be seen to now include Cell 1 instead of Cell 4.

In these embodiments, there are no changes to DCH active set 106, DCH monitored set 108 or detected set 112, although this may not necessarily be the case. In some embodiments, a serving HS-DSCH cell is a part of the active set (DCH active set) such that if a cell is replaced in the HS-DSCH active set, then that cell is also replaced in the DCH active set simultaneously. In other embodiments, replacement of a serving HS-DSCH cell can occur independently of the DCH active set, such that if a cell is replaced in the HS-DSCH active set, then replacing that cell in the DCH active set is optional.

In embodiments, a replacement activation threshold is defined and the UE activates the measurement reporting when the number of HS-DSCH active set cells becomes more than or equal to the replacement activation threshold.

Embodiments are able to advantageously re-use features of existing RRM algorithms to maintain the measurement configurations for HSDPA multiflow data transmission operation. Further, re-use of existing intra-frequency reporting events and measurement evaluation procedures, whilst applying new conditions, facilitates and simplifies implementation of embodiments in existing network infrastructure.

In first embodiments, a new RRC IE indicating the measurement instance made for HSDPA multiflow data transmission is introduced. The new IE comprises a MeasurementControl message which indicates whether the configured measurement applies for the HS-DSCH active set and HS-DSCH monitored set cells or not. If the new IE indicates that the measurement applies for HS-DSCH active set and HS-DSCH monitored set cells, then UE shall treat the “active set” parameter as the “HS-DSCH active set” and “monitored set” as “HS-DSCH monitored set” respectively and perform the configured measurement accordingly (e.g. “active set” or “monitored set” signalled in IE “triggering condition1”, IE “triggering condition2” and IE “Reporting cell status” or “active set” and “monitored set” as per 3GPP specification 25.331). Such re-use allows events 1a, 1b, 1c, 1e, and 1f in 3GPP specification 25.331 to relate to the first to fifth intra-frequency reporting events respectively as described above. For the sixth intra-frequency reporting event, if the new IE indicates that the measurement applies for HS-DSCH active set and HS-DSCH monitored set cells, then the UE shall treat the enhanced dedicated channel active set (“E-DCH active set”) as the “HS-DSCH active set” and perform the configured measurement accordingly (i.e. the “E-DCH active set” (e.g. as per 3GPP specification 25.331) is treated as the HS-DSCH active set).

In embodiments, the new RRC IE is present “per event configuration” as opposed to “per measurement control message” in the preceding paragraph. In such embodiments, the MeasurementControl message can contain more than one event configuration, for example all three of the first, second and third intra-frequency reporting events can be configured via one MeasurementControl message.

In second embodiments, several new triggering conditions are introduced. A new IE “triggering condition 4” is introduced which indicates “HS-DSCH active set cells only”, “HS-DSCH monitored set cells only”, “HS-DSCH active set and HS-DSCH monitored set cells”, “detected set cells only”, or “detected set and HS-DSCH monitored set cells”. A new IE “triggering condition 3” is also introduced which can indicate “HS-DSCH active set cells only”, “HS-DSCH monitored set cells only”, “HS-DSCH active set and HS-DSCH monitored set cells”. A further new IE “Reporting cell status for HS-DSCH” is introduced which replaces “active set” (e.g. as per 3GPP specification 25.331) with “HS-DSCH active set” and “monitored set” (e.g. as per 3GPP specification 25.331) with “HS-DSCH monitored set” in the existing IE “Reporting cell status”.

In the second embodiments, to realise the first intra-frequency reporting event, the new triggering condition “triggering condition 4” is applied for the existing (e.g. as per 3GPP specification 25.331) event 1a intra-frequency reporting event.

In the second embodiments, to realise the second intra-frequency reporting event, the new triggering condition “triggering condition 3” is applied for the existing (e.g. as per 3GPP specification 25.331) event 1b intra-frequency reporting event.

In the second embodiments, to realise the third intra-frequency reporting event, the existing (e.g. as per 3GPP specification 25.331) event 1c measurement is applied to the HS-DSCH active set cells instead of the DCH active set cells so that the UE can compare the cell's quality between HS-DSCH active set cells and HS-DSCH monitored set cells and/or detected set cells.

In the second embodiments, to realise the fourth intra-frequency reporting event, the new triggering condition “triggering condition 4” is applied to the existing (e.g. as per 3GPP specification 25.331) event 1e intra-frequency reporting event.

In the second embodiments, to realise the fifth intra-frequency reporting event, the new triggering condition “triggering condition 3” is applied to the existing (e.g. as per 3GPP specification 25.331) event 1f intra-frequency reporting event.

In the second embodiments, to realise the sixth intra-frequency reporting event, the existing (e.g. as per 3GPP specification 25.331) event 1j measurement is applied to the HS-DSCH active set cells and the active DCH active set cells.

The new IE “Reporting cell status for HS-DSCH” can apply for all the intra-frequency reporting events described above.

For both the first and second embodiment, an IE “frequency info” is added in the IE “Intra-frequency measurement reporting criteria” so that the NW can configure the measurements on the designated carrier frequency accordingly.

Re-use of existing intra-frequency reporting events is thus advantageously provided by the first and second embodiments.

In embodiments, the measurement report transmitted from the UE to the NW includes an identifier indicating that the measurement report is associated with the downlink packet access service. The identifier may comprise a measurement report identifier which is specific to a measurement report generated in relation to a downlink packet access service. The measurement report identifier may be an identifier only allocated to a HSDPA service.

In embodiments, the transmitted measurement report comprises an identifier for a met reporting criterion which is specific to a reporting criterion associated with a downlink packet access service.

In embodiments, the transmitted measurement report is defined specifically for use in relation to the downlink packet access service.

In embodiments, the received packet data is received from at least two serving downlink shared channel cells operating within the same carrier frequency provided by a single network transceiver entity, for example a base station, Node B or evolved Node B.

In embodiments, the received packet data is received from at least two serving downlink shared channel cells provided by different network transceiver entities, for example base stations, Node Bs or evolved Node Bs.

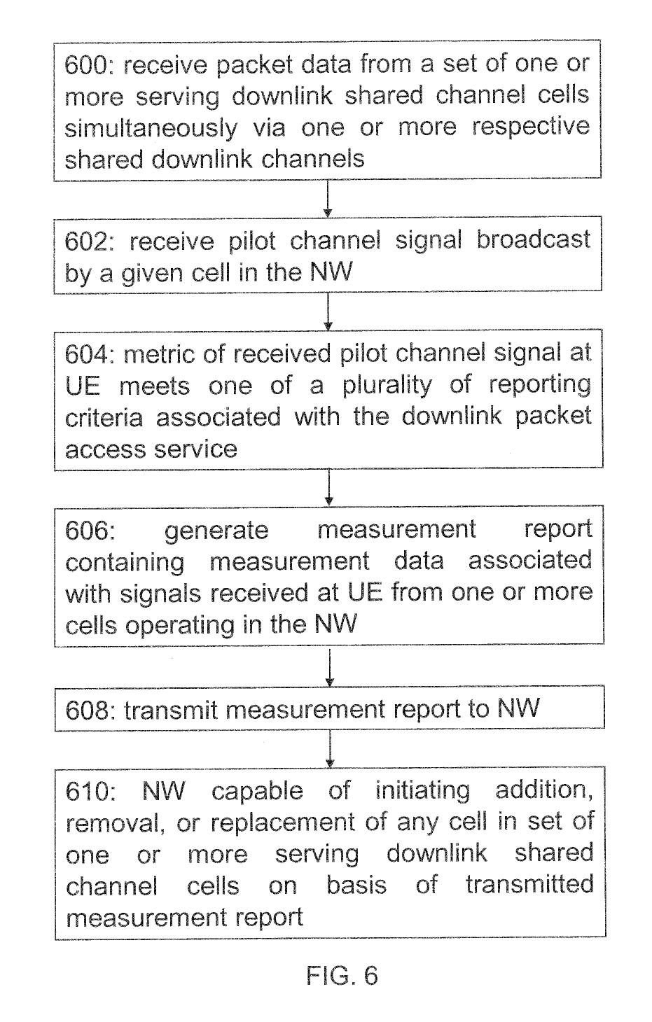

FIG. 6 shows a flow diagram according to embodiments for enabling mobility in a downlink packet access service in a wireless communications network from a UE perspective. In step 600, packet data transmitted from a set of one or more serving downlink shared channel cells simultaneously via one or more respective shared downlink channels is received at the UE. In step 602, a pilot channel signal broadcast by a given cell in the NW is received at the UE. In step 604, the UE determines that a metric of the received pilot channel signal at the UE meets one of a plurality of reporting criteria associated with the downlink packet access service. In step 606, a measurement report containing measurement data associated with signals received at the UE from one or more cells operating in the network is generated by the UE. In step 608, the UE transmits a measurement report to the NW. In step 610, the NW is capable of initiating addition, removal, or replacement of any cell in the set of one or more serving downlink shared channel cells on the basis of the transmitted measurement report.

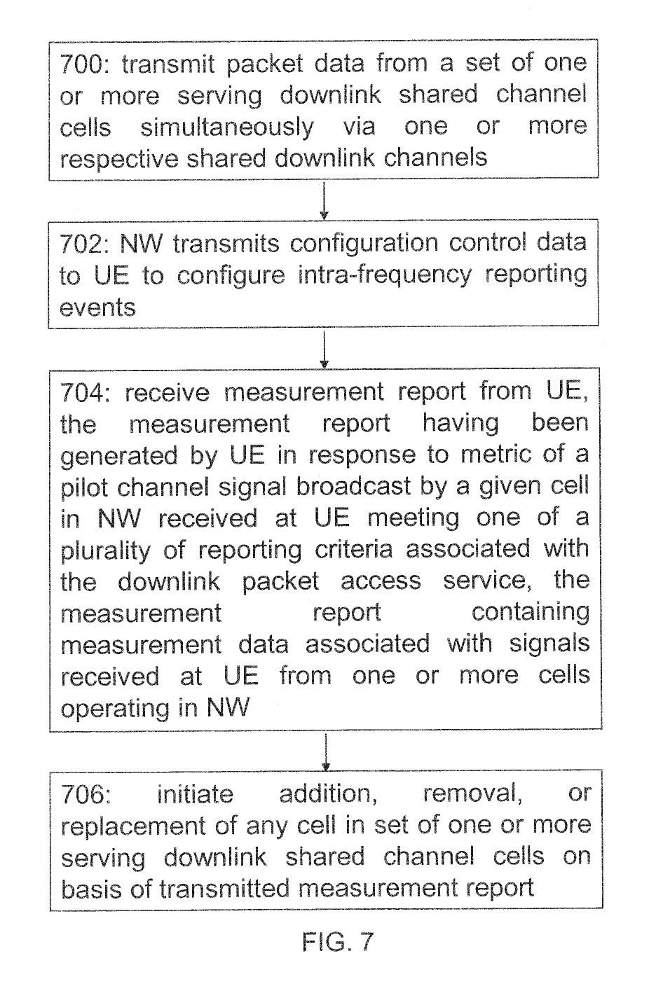

FIG. 7 shows a flow diagram according to embodiments for enabling mobility in a downlink packet access service in a wireless communications network from a NW perspective. In step 700, the NW transmits packet data from a set of one or more serving downlink shared channel cells simultaneously via one or more respective shared downlink channels to the UE. In step 702, the NW transmits configuration control data to the UE to configure the intra-frequency reporting events on the UE. In step 704, the NW receives a measurement report from the UE, the measurement report having been generated by the UE in response to a metric of a pilot channel signal broadcast by a given cell in the NW received at UE meeting one of a plurality of reporting criteria associated with the downlink packet access service. The measurement report contains measurement data associated with the signals received at the UE from one or more cells operating in the NW. In step 706, the NW initiates addition, removal, or replacement of any cell in the set of one or more serving downlink shared channel cells on the basis of the transmitted measurement report.

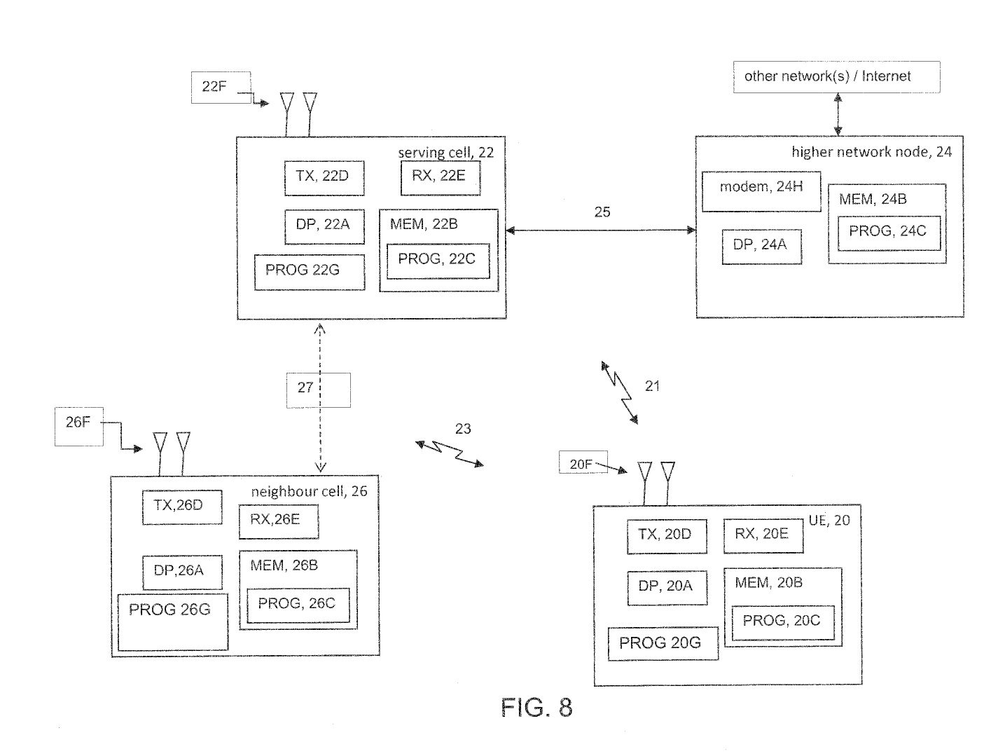

Reference is now made to FIG. 8 for illustrating a simplified block diagram of various electronic devices and apparatus that are suitable for use in a wireless communications network according to embodiments. FIG. 8 includes a serving cell/serving network access node 22 and a neighbour cell/neighbour network access node 26, which are adapted for communication over respective wireless links 21, 23 with an apparatus 20 such as mobile terminals or termed more generally as a user equipment UE. In certain networks, such as LTE, there is also an interface 27 between the serving 22 and neighbour 26 cell.

Serving cell 22 may comprise any of the serving cells, either DCH or HS-DSCH, described in embodiments above. Neighbour cell 26 may comprise any of the monitored, either DCH or HS-DSCH, or detected cells described in embodiments above. Serving cell 22 may be further communicatively coupled via link 25 to a higher network node 24, such as a radio network controller (RNC) in the case of the UMTS system or a mobility management entity/serving gateway MME/S-GW 24 in the case of the LTE system.

UE 20 includes processing means such as at least one data processor (DP) 20A, storing means such as at least one computer-readable memory (MEM) 20B storing at least one computer program (or ‘computer software’) (PROG) 20C, communicating means such as a transmitter TX 20D and a receiver RX 20E for bidirectional wireless communications with serving cell 22 and with neighbour cell 26 via one or more antennas 20F. Within memory 20B of UE 20 but shown separately as reference number 20G is also a computer program for enabling mobility procedures in relation to a multiflow downlink packet access service according to various embodiments described above.

Serving cell 22 also includes processing means such as at least one data processor

(DP) 22A, storing means such as at least one computer-readable memory (MEM) 22B storing at least one computer program (PROG) 22C, and communicating means such as a transmitter TX 22D and a receiver RX 22E for bidirectional wireless communications with its associated user devices 20 via one or more antennas 22F and a modem. Serving cell 22 also has stored in its memory at 22G, software for enabling mobility procedures in relation to a multiflow downlink packet access service according to various embodiments described above.

Neighbour cell 26 is similarly functional to serving cell 22 with blocks 26A, 26B, 26C, 26D, 26E, 26F and 26G. By example, serving cell 22 and neighbour 26 may comprise a node B (UMTS) or an e-NodeB (LTE) and in the case of the LTE system, interface 27 may comprise an X2 interface between them.

For completeness, the higher network node 24 is also shown to include a DP 24A, and a MEM 24B storing a PROG 24C, and additionally a modem 24H for communicating with at least the serving cell 22 (to show embodiments in which neighbour cell 26 is not under the same higher network node). Whilst not particularly illustrated for UE 20 or cells 22, 26, those devices are also assumed to include as part of their wireless communicating means a modem which may in one exemplary but non-limiting embodiment be inbuilt on an RF front end chip so as to carry the respective TX 20D/22D/26D and RX 20E/22E/26E.

At least one of the PROGs 20C and 20G, 22C and 22G, 26C and 26G in UE 20 and in serving and neighbour cells 22, 26 is assumed to include program instructions that, when executed by the associated DP 20A, 22A, 26A, enable the device to operate in accordance with the exemplary embodiments of this invention as detailed more fully above. In this regard, the exemplary embodiments of this invention may be implemented at least in part by computer software stored on the MEM 20B, 22B, 26B which is executable by the DP 20A, 22A, 26A of the respective devices 20, 22, 26; or by a processing system; or by hardware, or by a combination of tangibly stored software and hardware (and tangibly stored firmware). Electronic devices implementing these aspects of the invention need not be the entire UE 20, or serving cell 22, or neighbour cell 26, but exemplary embodiments may be implemented by one or more components of same such as the above described tangibly stored software, hardware, firmware and DP, or a system-on-a-chip SOC or an application specific integrated circuit ASIC or a digital signal processor DSP or a modem or a subscriber identity module (such as a SIM card).

Various embodiments of the UE 20 can include, but are not limited to: mobile (or ‘cellular’) telephones; data cards, USB dongles, personal portable digital devices having wireless communication capabilities including but not limited to laptop/palmtop/tablet computers, digital cameras and music devices, and Internet appliances.

Various embodiments of the computer readable MEM 20B, 22B, 26B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DP 20A, 22A, 26A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant art in view of the foregoing description. While the exemplary embodiments have been described above principally in the context of the UMTS system, it should be appreciated that the exemplary embodiments of this invention are not limited for use with only these particular types of wireless communication system, and that they may be used to advantage in other wireless communication systems, such as for example LTE/LTE-A and WCDMA and others.

The above embodiments are to be understood as illustrative examples of the invention. Further embodiments of the invention are envisaged.

Embodiments comprise a method for enabling mobility in a multiflow downlink packet access service in a wireless communications network, the method comprising, at a user equipment:

receiving packet data from a set of two or more serving downlink shared channel cells simultaneously via two or more respective shared downlink channels;

transmitting a measurement report associated with the downlink packet access service,

wherein the service is capable of initiating an addition of at least one, removal of any of the, or replacement of any of the, serving downlink shared channel cells in the set on the basis of the transmitted measurement report.

Embodiments comprise a method for enabling mobility in a multiflow downlink packet access service in a wireless communications network, the method comprising:

transmitting packet data from a set of two or more serving downlink shared channel cells simultaneously via two or more respective shared downlink channels to a user equipment;

receiving, from the user equipment, a measurement report associated with the downlink packet access service; and

initiating an addition of at least one, removal of any of the, or replacement of any of the, serving downlink shared channel cells in the set on the basis of the received measurement report.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for enabling mobility in a downlink packet access service in a wireless communications network, said method comprising, at a user equipment:
receiving packet data from a set of one or more serving downlink shared channel cells simultaneously via one or more respective shared downlink channels; and
transmitting a measurement report associated with said downlink packet access service,
wherein said service is capable of initiating an addition or removal of at least one, or replacement of any, of said serving downlink shared channel cells in said set on the basis of said transmitted measurement report.

2. A method according to claim 1, said method comprising receiving, at said user equipment, a pilot channel signal broadcast by a given cell in said network,
wherein said measurement report is generated by said user equipment in response to a given metric of said pilot channel signal received at said user equipment meeting one or more of a plurality of reporting criteria associated with said downlink packet access service.

3. A method according to claim 2, wherein said given metric comprises one or more of a pathloss, a measure of signal strength and a measure of signal quality.

4. A method according to claim 2, wherein said met reporting criteria comprise said given metric of said received pilot channel signal entering a reporting range or becoming better than an absolute threshold, and
wherein said service is capable of adding said given cell to said set of serving downlink shared channel cells on the basis of said transmitted measurement report.

5. A method according to claim 4, wherein said met reporting criteria further comprise said given cell being in one of:
a) said set of serving downlink shared channel cells;
b) a set of one or more cells monitored by said user equipment in relation to said downlink packet access service;
c) said set of serving downlink shared channel cells or said set of one or more cells monitored by said user equipment in relation to said downlink packet access service;
d) a set of one or more cells detected by said user equipment; or
e) said set of one or more cells detected by said user equipment or said set of one or more cells monitored by said user equipment in relation to said downlink packet access service.

6. A method according to claim 2, wherein said met reporting criteria comprise said given metric of said received pilot channel signal leaving a reporting range or becoming worse than an absolute threshold, and
wherein said service is capable of removing said given cell from said set of serving downlink shared channel cells on the basis of said transmitted measurement report.

7. A method according to claim 6, wherein said met reporting criteria further comprise said given cell being in one of:
a) said set of serving downlink shared channel cells;
b) a set of one or more cells monitored by said user equipment in relation to said downlink packet access service; or
c) said set of serving downlink shared channel cells or said set of one or more cells monitored by said user equipment in relation to said downlink packet access service.

8. A method according to claim 2, wherein said met reporting criteria comprise said given metric of said pilot channel signal received from said given cell becoming better than the same metric of a pilot channel signal received at said user equipment from at least one cell in said set of serving downlink shared channel cells, and
wherein said service is capable of replacing a cell in said set of serving downlink shared channel cells with said given cell on the basis of said transmitted measurement report.

9. A method according to claim 8, wherein said met reporting criteria further comprise said given cell comprising a cell for a dedicated channel communication service, but not comprising a cell in said set of serving downlink shared channel cells.

10. A method according to claim 1, wherein said measurement report comprises measurement data associated with the pathloss, signal strength and/or signal quality of signals received at said user equipment from one or more cells operating in said network.

11. A method according to claim 10, wherein said one or more cells operating in said network comprise:
a) said set of serving downlink shared channel cells;
b) a set of one or more cells monitored by said user equipment in relation to said downlink packet access service;
c) said set of serving downlink shared channel cells and said set of one or more cells monitored by said user equipment in relation to said downlink packet access service;
d) a set of one or more cells detected by said user equipment; or
e) said set of one or more cells detected by said user equipment and said set of one or more cells monitored by said user equipment in relation to said downlink packet access service.

12. A method according to claim 11, wherein said user equipment is configured to include measurement data associated with either a), b), c), d) or e) in said measurement report according to configuration control data received from said network.

13. A method according to claim 1, wherein said transmitted measurement report includes an identifier indicating that said measurement report is associated with said downlink packet access service.

14. A method according to claim 1, wherein said transmitted measurement report comprises an identifier for a met reporting criterion which is specific to a reporting criterion associated with said downlink packet access service.

15. A method according to claim 1, wherein said transmitted measurement report is defined specifically for use in relation to said downlink packet access service.

16. Apparatus for use in enabling mobility in a downlink packet access service in a wireless communications network, said apparatus comprising a processing system comprising at least one processor and at least one memory storing a set of computer instructions, in which the processing system is arranged to cause the apparatus at least to, at a user equipment:
receive packet data from a set of one or more serving downlink shared channel cells simultaneously via one or more respective shared downlink channels; and
transmit a measurement report associated with said downlink packet access service,
wherein said service is capable of initiating an addition or removal of at least one, or replacement of any, of said serving downlink shared channel cells in said set on the basis of said transmitted measurement report.

17. A computer program product comprising a non-transitory computer-readable storage medium having computer readable instructions stored thereon, the computer readable instructions being executable by a computerized device to cause the computerized device to perform a method for enabling mobility in a downlink packet access service in a wireless communications network, the method comprising, at a user equipment:
receiving packet data from a set of one or more serving downlink shared channel cells simultaneously via one or more respective shared downlink channels; and
transmitting a measurement report associated with said downlink packet access service,
wherein said service is capable of initiating an addition or removal of at least one, or replacement of any, of said serving downlink shared channel cells in said set on the basis of said transmitted measurement report.

18. A method for enabling mobility in a downlink packet access service in a wireless communications network, said method comprising, at a network device:
transmitting packet data from a set of one or more serving downlink shared channel cells simultaneously via one or more respective shared downlink channels to a user equipment;
receiving, from said user equipment, a measurement report associated with said downlink packet access service; and
initiating an addition or removal of at least one, or replacement of any, of said serving downlink shared channel cells in said set on the basis of said received measurement report.

19. A method according to claim 18, wherein said measurement report comprises measurement data associated with the pathloss, signal strength and/or signal quality received at said user equipment from one or more cells operating in said network.

20. A method according to claim 19, wherein said one or more cells operating in said network comprise:
a) said set of serving downlink shared channel cells;
b) a set of one or more cells monitored by said user equipment in relation to said downlink packet access service;
c) said set of serving downlink shared channel cells and said set of one or more cells monitored by said user equipment in relation to said downlink packet access service;
d) a set of one or more cells detected by said user equipment; or
e) said set of one or more cells detected by said user equipment and said set of one or more cells monitored by said user equipment in relation to said downlink packet access service.

21. A method according to claim 20, comprising transmitting configuration control data to said user equipment, said configuration control data being operable to configure said user equipment to include measurement data associated with either a), b), c), d) or e) in said measurement report.

22. A method according to claim 18, wherein said received measurement report includes an identifier indicating that said measurement report is associated with said downlink packet access service.

23. A method according to claim 18, wherein said transmitted packet data is transmitted from at least two serving downlink shared channel cells operating within the same carrier frequency provided by a single network transceiver entity.

24. A method according to claim 18, wherein said transmitted packet data is transmitted from at least two serving downlink shared channel cells provided by different network transceiver entities.

25. Apparatus for use in enabling mobility in a downlink packet access service in a wireless communications network, said apparatus comprising a processing system comprising at least one processor and at least one memory storing a set of computer instructions, in which the processing system is arranged to cause the apparatus at least to:
transmit packet data from a set of one or more serving downlink shared channel cells simultaneously via one or more respective shared downlink channels to a user equipment;
receive, from said user equipment, a measurement report associated with said downlink packet access service; and
initiate an addition or removal of at least one, or replacement of any, of said serving downlink shared channel cells in said set on the basis of said received measurement report.

26. A computer program product comprising a non-transitory computer-readable storage medium having computer readable instructions stored thereon, the computer readable instructions being executable by a computerized device to cause the computerized device to perform a method for enabling mobility in a downlink packet access service in a wireless communications network, said method comprising:
transmitting packet data from a set of one or more serving downlink shared channel cells simultaneously via one or more respective shared downlink channels to a user equipment;
receiving, from said user equipment, a measurement report associated with said downlink packet access service; and
initiating an addition or removal of at least one, or replacement of any, of said serving downlink shared channel cells in said set on the basis of said received measurement report.
